(19) United States
(12) Patent Application Publication
(10) Pub. No.: US 2016/0042356 A1
(43) Pub. Date: Feb. 11, 2016

(54) Biometric Reading Governing Commercial Transactions via Smart Devices

(71) Applicants: Gabriel Jakobson, Alamo, CA (US); Steven Rueben, Las Vegas, NV (US)

(72) Inventors: Gabriel Jakobson, Alamo, CA (US); Steven Rueben, Las Vegas, NV (US)

(21) Appl. No.: 14/121,219

(22) Filed: Aug. 11, 2014

(51) Int. Cl. G06Q 20/40; G06Q 20/20; G06Q 20/32; G06K 9/00

(52) U.S. Cl. CPC G06Q 20/40145; G06K 9/00013; G06Q 20/202; G06Q 20/3278

(57) ABSTRACT

A method of performing commercial transactions, comprising: establishing a secure link over an air interface by a purchasing device (e.g. a wearable computing device, a smart phone, etc.), the secure link being between the purchasing device and a point of sale device; obtaining a biometric read on the purchasing device; authenticating the biometric read on the purchasing device; conducting a secure commercial transaction between the purchasing device and the point of sale device, wherein the commercial transaction is carried out via an electronic transmission between the air interface of the purchasing device and the point of sale, and wherein payment information stored securely on the purchasing device is transmitted to the point of sale device as part of the electronic transmission. In another possible embodiment, obtaining a biometric read on a purchasing device places the purchasing device in a “ready to transact” state for a timed period.

### FIELD OF INVENTION

The present invention generally relates to commercial transactions via electronic devices (e.g. smart phone, wearable computer, etc.) More particularly, the present invention relates to a system governing a commercial transaction between an electronic device and a point-of-sale via a biometric reader on the electronic device.

### BACKGROUND OF THE INVENTION

Smart phones (e.g. iPhone® models, Android®-based smart phones) and wearable computers (e.g. smart watches from Samsung®, Sony®, Pebble® etc, Google Glass™, etc.) are generally equipped with means of communicating with other devices via technologies such as Bluetooth/Bluetooth Low Energy (“BLE”), Near-Field Communication (“NFC”) technologies, etc. Communication between electronic devices is utilized in the prior art to conduct commercial transactions. For example, a smart phone utilizing a service such as Google Wallet® may come in close proximity with a point-of-sale (“POS”) device and utilize NFC communication to transmit payment information from the smart phone to the POS. In a similar example, an iPhone® or similar Apple® smart device may utilize iBeacon® to transmit payment information (e.g. over a Bluetooth 4.0/BLE protocol) to a POS to transmit a mobile payment without the use of physical money or credit cards.

Mobile payment, also referred to as mobile money, mobile money transfer, and mobile wallet generally refer to payment services operated under financial regulation and performed from or via a mobile device. Instead of paying with cash or credit cards, a consumer can use a mobile phone to pay for a wide range of services and digital or hard goods. Some example of mobile payment providers/technologies are companies like Square, Inc. Square Register® allows individuals and businesses to accept debit and credit cards on their iOS® or Android® smartphone or tablet computer. The app supports manually entering the card details or swiping the card through the Square Reader, a small plastic device which plugs into the audio jack of a supported smartphone or tablet and reads the magnetic stripe. On the iPad® version of the Square Register app, the interface resembles a traditional cash register. Square Wallet® allows customers to set up a tab and pay for their order simply with their name (or a barcode) using a stored credit, debit, or gift card.

Biometric readers, most notably fingerprint scanners, are integrated into a plurality of smart devices, e.g. the Touch ID fingerprint identity sensor built into the Apple® iPhone® 5S and Samsung Galaxy® 5S smart phones. Biometric readers are generally used to ensure the identity of the user of the device (e.g. a user scans in their fingerprint to unlock their electronic device.) or in some cases, to authorize electronic payments already in progress. For example, a user going through an on-line purchase-flow on iTunes® using an iPhone® may be required to scan their thumbprint as the final “authorization step” of the transaction. However, for in-person transactions (i.e not online) there is no mechanism in the prior art to govern an electronic commercial transaction, conducted via an air interface on the smart device against a point-of-sale, with use of a biometric reader on the smart device.

### SUMMARY OF THE INVENTION

In general, a method and system for facilitating commercial electronic transactions via portable electronic smart devices that are equipped with a biometric reader, wherein the biometric reader is utilized to place the electronic device in a timed “ready-to-transact” state. The commercial electronic transaction may take place via an air interface of the portable electronic smart device, allowing payment information stored securely on the smart device to be transmitted to a point-of-sale. In one possible embodiment, the “ready-to-transact” state may be timer-driven, and only electronic transactions conducted between the time the electronic device is placed in the “ready-to-transact” state, and the time before the “ready-to-transact” state expires, are valid.

For example, a user of a smart phone equipped with a fingerprint identity sensor may use their phone to play music and for other activities, while strolling in a store equipped with mobile POS stations. Any electronic communication between the electronic device and the POS (e.g. via “always-on” technologies such as BLE and NFC) that may construe a purchase transaction, is rejected. When the user decides to commence an electronic purchase, the user may slide his/her fingers on the fingerprint sensor of their device. Once the device has authenticated the fingerprint as belonging to the user, the device may be placed in a “ready to transact” mode; i.e. communicating with the POS and ready to transmit and receive any transaction-related information. The “ready to transact” mode may be timed, such that after a pre-set duration, the “ready to transact” mode is automatically cancelled and any further BLE/NFC communications between the device and the POS may be considered invalid for transactions.

### DESCRIPTION OF THE DRAWINGS

For a more complete understanding of the present invention and further advantages thereof, references are now made to the following Detailed Description, taken in conjunction with the drawings, in which:

FIGS. 1a and 1b are generalized block diagrams illustrating a system which enables and electronic device to conduct an electronic transaction via an air interface following a biometric scan on the electronic device.

FIGS. 2a-2c are generalized flow diagrams illustrating a system which enables an electronic device to conduct an electronic transaction via an air interface following a biometric scan on the electronic device.

FIGS. 3a-3d are generalized block diagrams illustrating a system enabling a portable electronic device to conduct commercial transactions via an air interface following a biometric scan, in one possible embodiment of the present invention.

### DETAILED DESCRIPTION

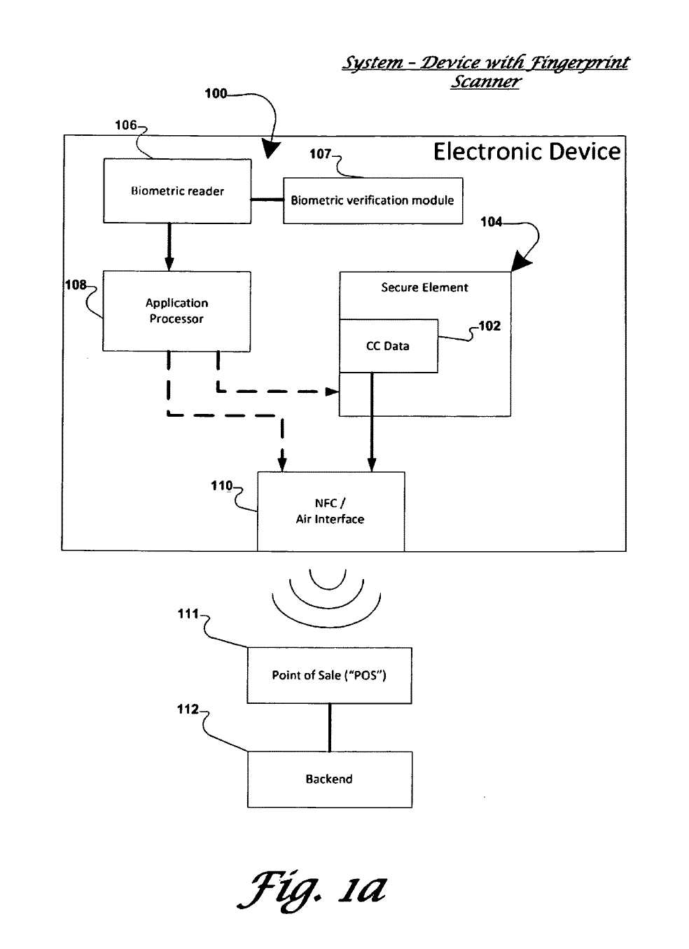

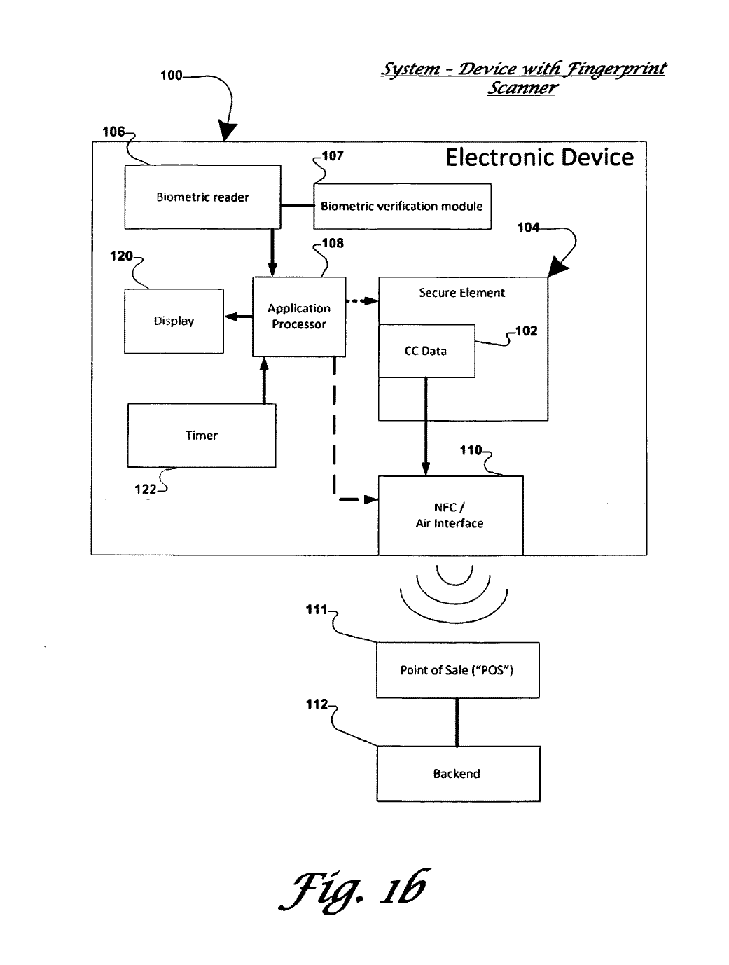

FIGS. 1a and 1b are generalized block diagrams illustrating a system which enables and electronic device to conduct an electronic transaction via an air interface following a biometric scan on the electronic device. In one possible embodiment of the present invention, referring to FIG. 1a, a portable electronic device 100 may include a secure element (“SE”) 104 which may include digitally-stored payment information, e.g. credit card data 102. The portable electronic device 100 may also include an application processor (“AP”) 108 that executes applications to conduct electronic transactions, such as purchase goods and services using the credit card information 102 from a point-of-sale (“POS”) 111 (please note that a POS in this invention may refer either to a conventional POS terminal at a store; or, to another portable electronic device acting as a POS in a peer-to-peer electronic transaction.) The portable electronic device 100 may also include at least one air interface 110 (e.g. a near-field communication (“NFC”) module). The air interface 110 may establish an electronic wireless transmission with the POS 111, allowing for exchange of transaction-related information, such as the credit card data 102. The POS 111 may be linked/part-of a backend system 112 (e.g. bank), configured to execute commercial transactions against the credit card data 102.

A biometric reader 106 (e.g. fingerprint scanner) may be associated with the portable electronic device 110 (e.g. be built-in as part of the device's 110 hardware) and may communicate with the AP 108. The biometric reader 106 may be paired with a biometric verification module 107, whose purpose is to validate the biometric input. Please note that the biometric verification module 107 is represented herein as a separate module for illustrative purpose only; it may be an algorithm that is run by a separate processor, by the OS of the device, by any other module, hardware or software, etc. (e.g. by AP 108).

The biometric reader 106 may function as a “gate keeper”, allowing and disallowing communications between the air interface 110 and the POS 111, over which information from the SE 104 is transmitted. In one possible embodiment, a communication link between the air interface 110 and the POS 110 may be established (e.g. a NFC link) prior to a successful biometric read; however, the payment/credit card data 102 stored in the secure element 104 may not be transmitted to the POS 110 via the air interface 110 until a positive biometric read has been received by the biometric reader 106, and verified by the biometric verification module 107. For example, a user of a portable electronic device, e.g. a smart watch, may tap the smart watch on a touchpad of a POS. A communication may be established, prompting the user to swipe his/her finger across the finger scanner of the smart watch in order to transmit a credit card number, stored on the smart watch, to the POS.

In another possible embodiment, communication between the air interface 110 and the POS 111 may be contingent upon a successful biometric read on the portable electronic device 100. In other words, the electronic device 100 and the POS 111 may engage in a transaction-related communication only once the user of the electronic device 100 has placed the electronic device 100 in a “transaction-ready mode” by providing a successful biometric read. For example, a user of a smart watch operating according to the principles of the present invention, may place the smart watch in close proximity to a POS and observe that no communication is taking place between the POS and the smart watch. The act of successfully providing a biometric read, e.g. swiping finger across the biometric reader of the smart watch, “wakes up” the air interface of the smart watch (e.g. NFC, BLE, etc.) and allows the air interface to form a paired connection with the POS and start engaging in an electronic commercial transaction in which payment information stored on the smart watch is transmitted to the POS.

In another possible embodiment, referring now to FIG. 1b, the portable electronic device 100 may be additionally equipped with a display 120 and a timer 122. The display 120 may provide the user of the portable electronic device 100 with feedback relevant to the operation of the present invention. The timer 122 may provide means of automatically disabling an electronic transaction after an elapsed period of time. Please kindly note that the display 120 may be a general display of the portable electronic device 100, e.g. the main screen displaying phone calls etc. and the timer may be a subset of functionality provided by the operating system of the portable electronic device 100.

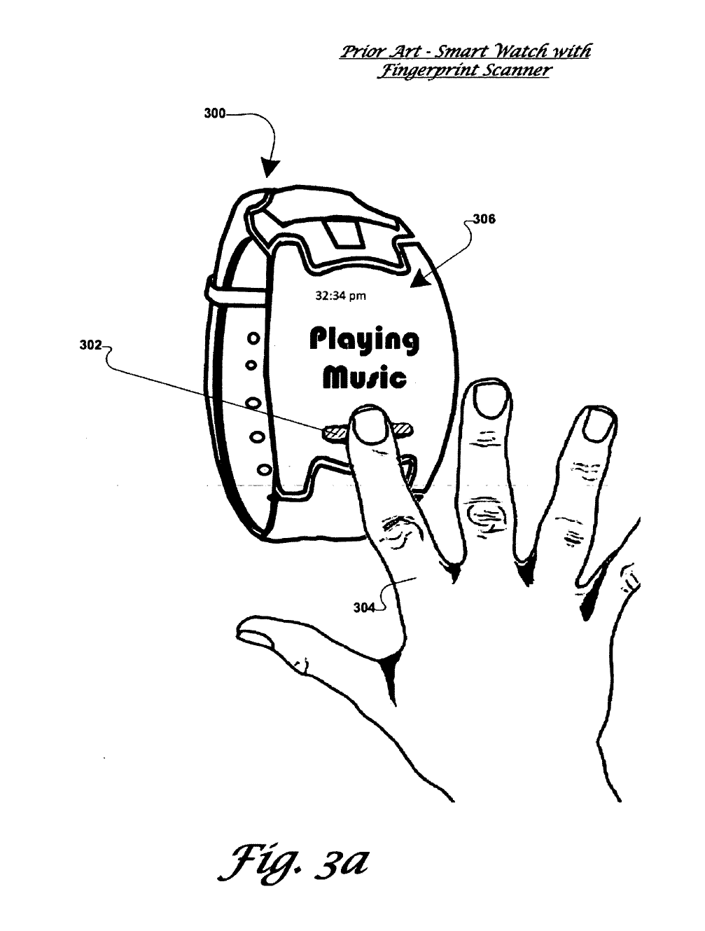

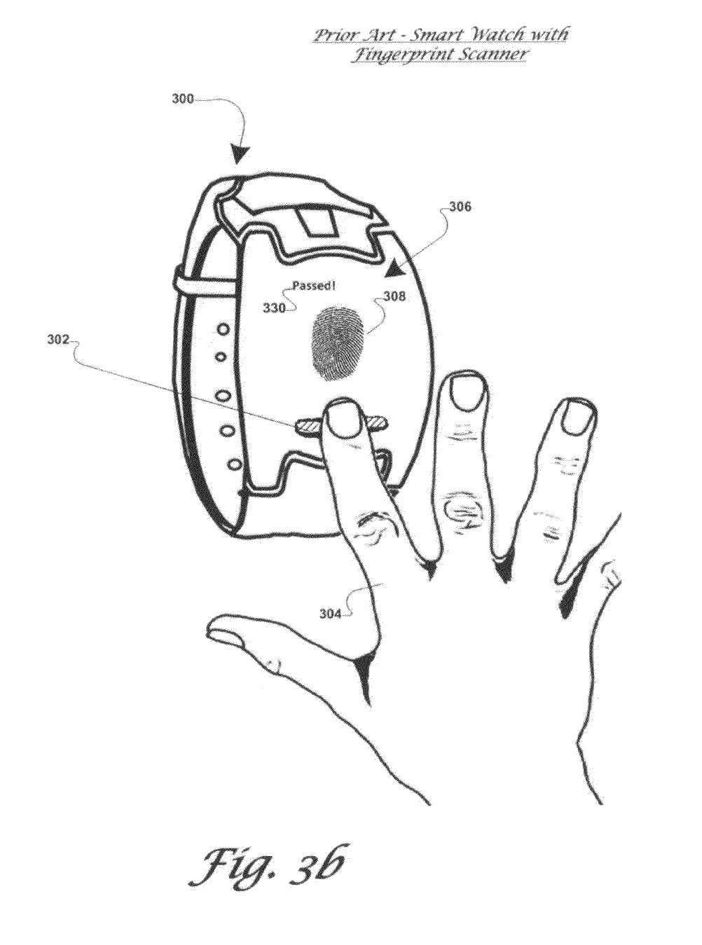

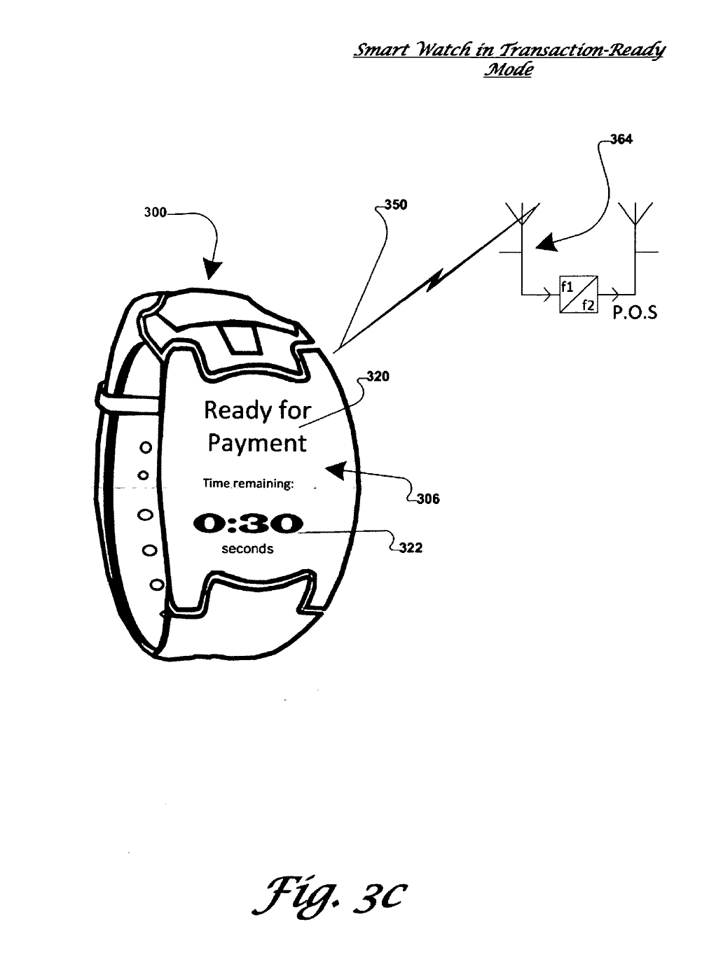

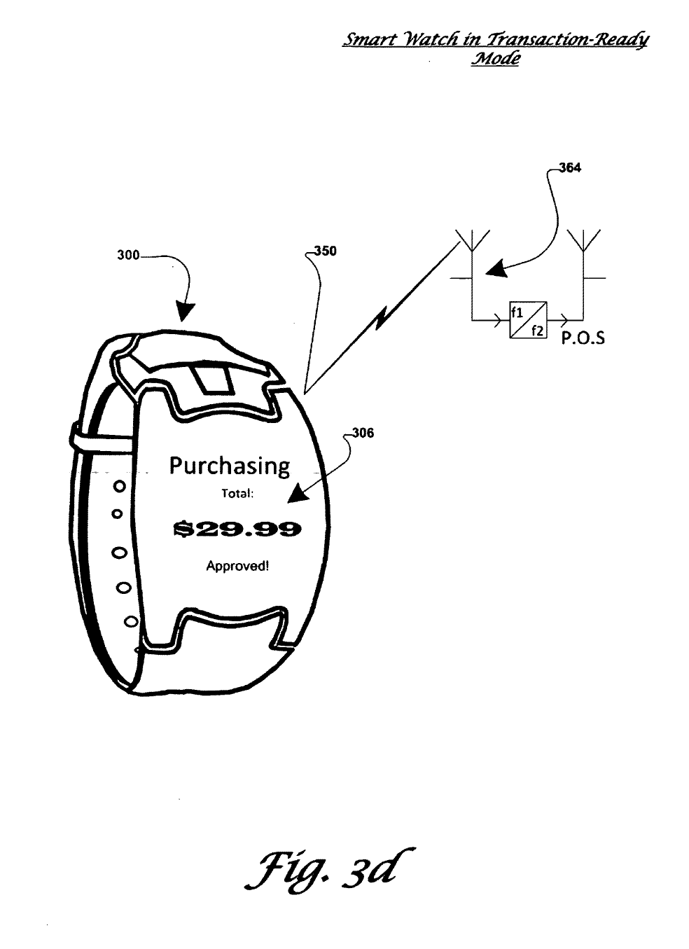

Communication between the portable electronic device 100 and the POS 111, facilitated via the air interface 110 and used to transmit the credit card/payment information 102, may be generally governed by a combination of a biometric read, its verification, a display and a timing mechanism. A successful biometric read, via the biometric reader 106 and its verification via the biometric verification module 107, may initialize the timer 122, in conjunction with allowing a communication between the air interface 110 and the POS 111, over which the credit card (or any other payment form) information 102, stored in the SE 104, may be transmitted to conduct an electronic commercial transaction. The timer 122 may be preset with a timeout interval at the end of which the transmission of the credit card data 102 to the POS 111 via the air interface 110 may be disallowed/aborted. The user may be notified via the display 120 of the status of the transaction allowance and/or time remaining until communication is shut off and transactions are disallowed. Please refer to FIGS. 3a-3c for an example illustrating this embodiment.

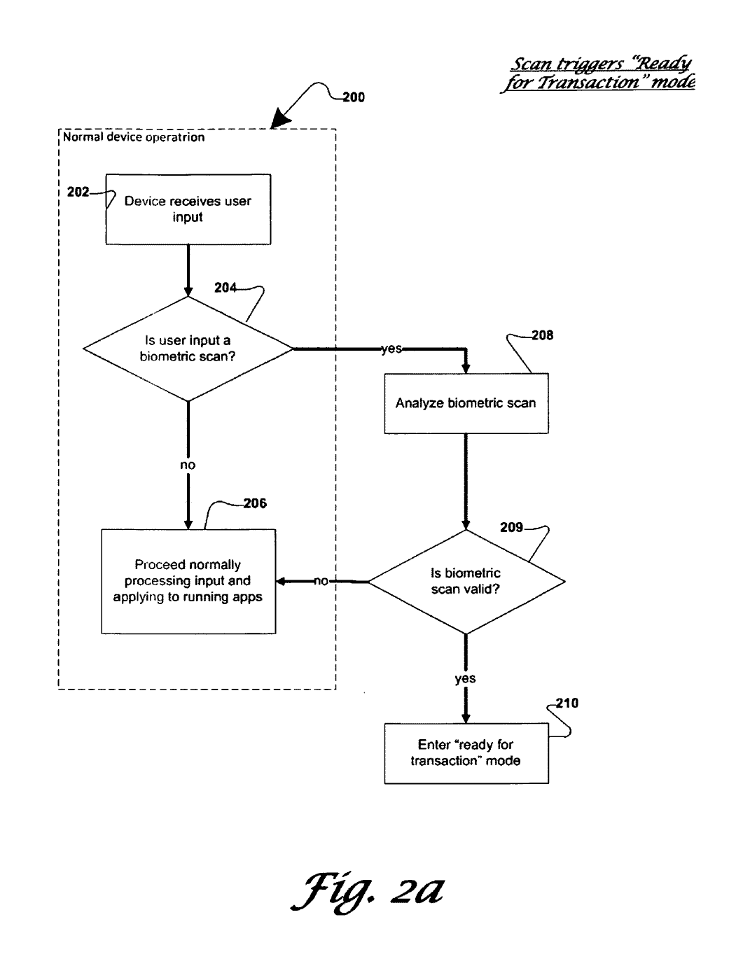

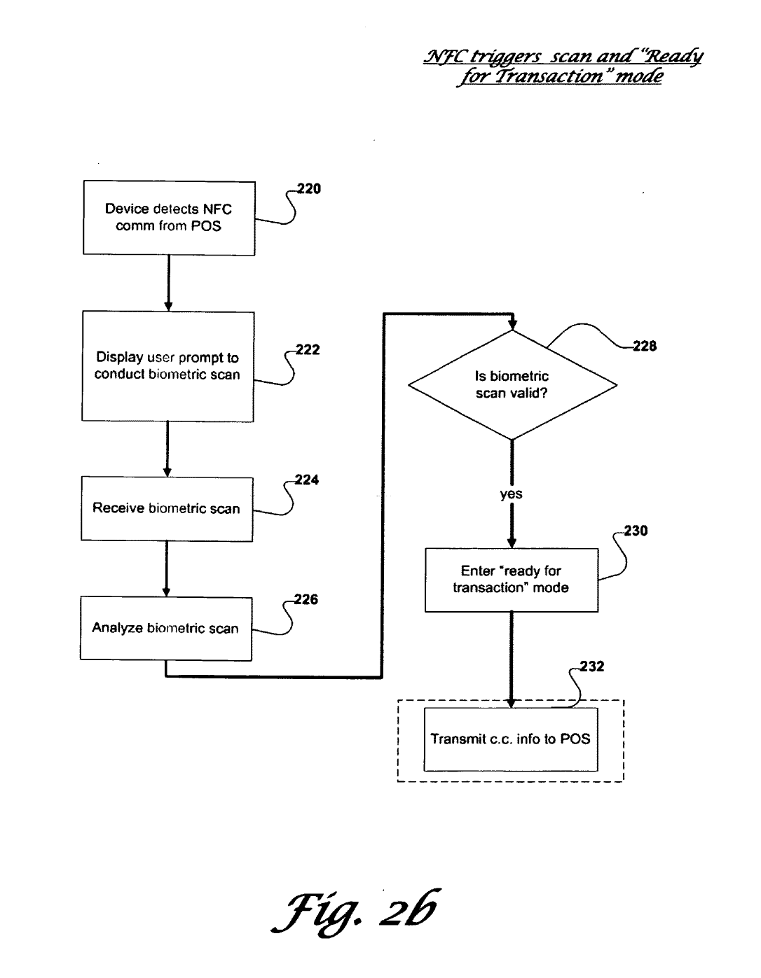

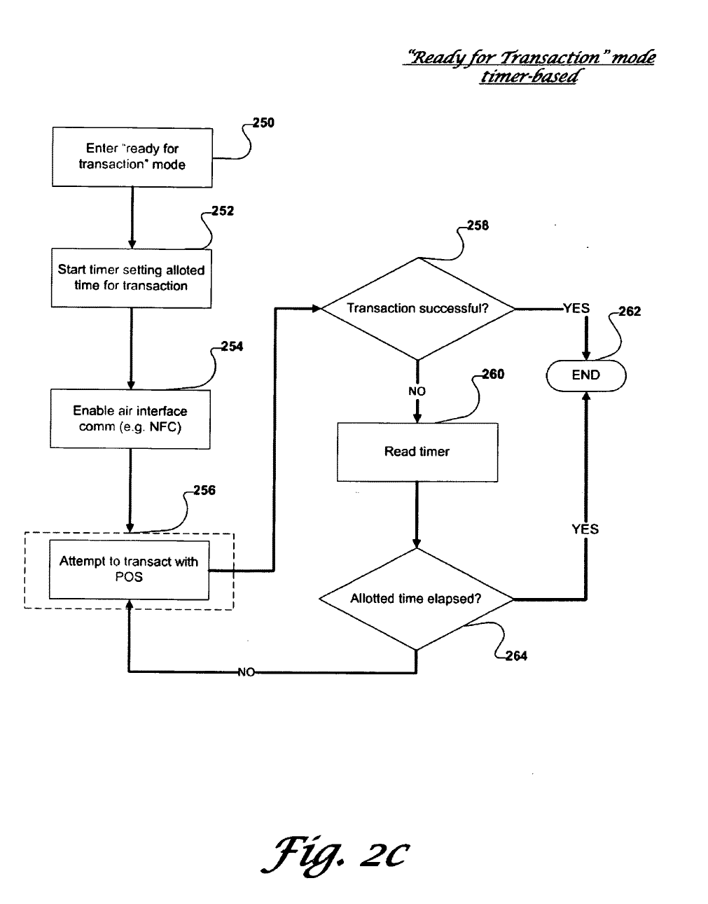

FIGS. 2a-2c are generalized flow diagrams illustrating a system which enables and electronic device to conduct an electronic transaction via an air interface following a biometric scan on the electronic device. In various possible embodiments described herein, a biometric scan may be used in various logical flows of a transactions process. For example, referring to FIG. 2a, a successful biometric scan may place an electronic device in a “ready state”, allowing the electronic device to use an air interface (e.g. NFC, BlueTooth etc.) to transmit payment information stored on the electronic device, to a POS.

Generalized step 200, encompassing steps 202-206, illustrates a normal operation of a portable electronic device: user input is received at step 202. At step 204 it is determined the user input is not a biometric scan and consequentially, at step 206 the user input is processed normally by the operating system of the electronic device. The assumed state of the electronic device in this example is generally turned on, with the user authenticated to the electronic device (i.e. past the initial security challenge which may itself require a biometric scan, which is outside the scope of the present invention.)

If at step 204 it is determined that the user input at step 202 was a biometric scan (e.g. a fingerprint scan), at step 208 the biometric scan may be analyzed (e.g. compared with stored biometric scans on the electronic device). At step 209 it may be determined whether the biometric scan is valid; if it is determined the biometric scan is not valid, at step 206 ordinary process/operation of the electronic device may resume (outside the scope of the present invention.) If it is determined at step 209 that biometric scan is valid, the electronic device may enter a “ready for transaction” state at step 210.

The “ready for transaction” state may have varied connotations in different possible embodiments, including, for example: the user may be prompted to touch the electronic device against a POS to commence an electronic transaction; a pending air interface connection may be confirmed; a pending transmission of securely stored payment information on the electronic device may be transmitted to the POS, etc.

Another possible embodiment is illustrated in FIG. 2b. The user's portable electronic device may detect an air interface communication (e.g. NFC) from a POS at step 220. At step 222, the device may display a prompt for the user to conduct a biometric scan on the electronic device in order to facilitate an electronic commercial transaction via the air interface. At step 224 the biometric scan may be received (e.g. user scans fingerprint on the device's fingerprint scanner), and at step 226 the received biometric scan may be analyzed. If it is determined at step 228 that the biometric scan is valid (validating biometric scans on electronic devices is well known in the prior art) at step 230 the portable electronic device may enter a “ready to transact” mode. As one of many possible embodiment of the “ready to transact” mode, at step 232 payment information stored securely on the portable electronic device may be transmitted to the POS over the air interface (i.e. allowing a commercial transaction to take place).

Referring now to FIG. 2c, “ready to transact” mode involve a timing mechanism regulating its duration. At step 250, the “ready to transact” mode may be instantiated. At step 252, a system timer may be invoked to allow for a pre-determined time span to elapse (e.g. through code by an application utilizing the OS of the portable electronic device.) At step 254, an air interface communication may be initialized/allowed to facilitate electronic transactions with a POS. At step 258 it may be determined whether an electronic transactions between the portable electronic device and the POS was successful; if it is determined the transaction was successful, at step 262 the logical flow described by the present invention may end.

If at step 258 it is determined the electronic transaction between the portable electronic device and the POS, via the electronic device's air interface, was not successful, at step 260 the timer may be read to determine whether the time-span allotted for the electronic transaction at step 252 has elapsed. If it is determined at step 264 the allotted time-span has elapsed, at step 262 the logical flow of this embodiment ends; otherwise, step 256 may be repeated, re-trying the transaction with the POS.

FIGS. 3a-3d are generalized block diagrams illustrating a system enabling a portable electronic device to conduct commercial transactions via an air interface following a biometric scan, in one possible embodiment of the present invention. Referring to FIG. 3a, a portable electronic device 300 (e.g. a smart watch) may include a display 306 and a biometric reader 302. The biometric reader 302 may be capable of receiving a biometric read from a human 304. The portable electronic device 300 may be capable of processing and validating the received biometric read.

Upon validating the biometric read, referring now to FIG. 3b, the display 306 may display indicators of a successful biometric read: a fingerprint image 308 and a message such as “passed” 330, as examples. Please kindly note that the displayed entities 308 and 330 are merely exemplary and are not germane to the present invention.

Referring now to FIG. 3c, the display 306 of the portable electronic device 300 may display further indicators to the user that the portable electronic device 300 is ready to conduct electronic commercial transactions. For example, a message “Ready for Payment” 320 may be displayed, along with a timed message 322 indicating to the user the remaining amount of time to conclude the electronic transaction (this specific illustration refers to one possible embodiment of invoking time-restrictive transactions via a biometric scan.) Communication (e.g. NFC, BLE, etc.) with a POS 364 may be facilitated via an air interface 350 on the portable electronic device 300.

Referring now to FIG. 3d, the display 360 of the portable electronic device 300 may display information related to the electronic commercial transaction with the POS 364, such as notifying a user of the value of the transaction (e.g. purchase price), requesting user approval, as the portable electronic device 300 communicates via link 350 with the POS 364.

While various embodiments of the present invention have been described in detail, it is apparent that further modifications and adaptations of the present invention will occur to those skilled in the art. However, it is to be expressly understood that such modifications and adaptations are within the spirit and scope of the present invention.

What is claimed is:

1. A method for utilizing an electronic device for payment, including:
presenting an electronic device coupled to a biometric reader and an air interface, and a point-of-sale device, wherein the electronic device and the point-of-sale device are within close proximity of each other allowing the electronic device and the point-of-sale device to establish electronic communication via the air interface;
receiving from the biometric reader a new biometric reading;
determining the new biometric reading matches a stored biometric reading identifying an authorized user of the electronic device;
initiating a transaction-ready state, wherein one or more new processes on the electronic device enable the electronic device to transmit and receive electronic payment-related communications to and from the point-of-sale device;
initiating a timer on the electronic device, wherein the timer has a pre-set expiration period;
determining the timer has reached end of the expiration period;
dis-allowing the electronic device to transmit and receive additional electronic payment-related communications to and from the point-of-sale device.

2. The method of claim 1, wherein the biometric reader is a fingerprint scanner.

3. The method of claim 2, wherein the biometric reading is a fingerprint scan.

4. The method of claim 1, wherein the air interface is via a near field communication (“NFC”).

5. The method of claim 1, wherein air interface is via a Bluetooth communication.

6. The method of claim 1, further including receiving from the point-of-sale an initial electronic payment-related communication prior to the initialization of the transaction-ready state, and rejecting the initial electronic payment-related communication.

7. The method of claim 1, wherein the step of initiating the transaction-ready state further includes displaying a visual indication on the electronic device that the electronic device is in transaction-ready state.

8. The method of claim 7, wherein upon determining time allotted by the timer has expired, removing the visual indication that the electronic device is in transaction-ready state.

9. The method of claim 1, wherein the one or more of the new processes allow displaying payment-related information by the electronic device from the point-of-sale device.

10. The method of claim 9, further receiving user input on the electronic device okaying the displayed payment-related information.

11. The method of claim 10, wherein the received user input is transmitted to the point-of-sale device.

12. The method of claim 1, wherein the one or more new processes represent a mobile-payment application compatible with the point-of-sale device.

13. The method of claim 12, wherein the fingerprint scan is in lieu of a personal identification number (“PIN”) required by the mobile-payment application.

14. The method of claim 1, wherein the step of initiating the transaction-ready state further includes turning on the air interface.

15. The method of claim 14, wherein upon determining time allotted by the timer has expired, turning off the air interface.

16. The method of claim 1, wherein all other electronic payment-related communications between the electronic device and the point-of-sale device, occurring before the step of initiating the transaction-ready state and after time allotted by the timer has expired, are considered invalid.

17. A method of performing commercial transactions, comprising:
establishing a secure link over an air interface by a purchasing device, the secure link being between the purchasing device and a point of sale device;
obtaining a biometric read on the purchasing device;
authenticating the biometric read on the purchasing device;
conducting a secure commercial transaction between the purchasing device and the point of sale device, wherein the commercial transaction is carried out via an electronic transmission between the air interface of the purchasing device and the point of sale, and wherein payment information stored securely on the purchasing device is transmitted to the point of sale device as part of the electronic transmission.

18. The method of claim 17, wherein the payment information resides in a secure element on the purchasing device.

19. The method of claim 18, wherein the payment information includes credit card information.

20. The method of claim 17, wherein a user of the purchasing device is prompted to provide a biometric scan prior to the step of obtaining the biometric scan.

21. The method of claim 17, wherein the biometric scan is a fingerprint.

22. The method of claim 17, wherein the air interface is a near-field communication module.

23. A system comprising:
a purchasing device and a point of sale device;
the purchasing device is configured to:
store payment information;
establish a secure link over an air interface with the point of sale device; validate a user via a biometric scan; and
transmit the payment information to the point of sale device via the secure link.

24. The system of claim 23, wherein the purchasing device is configured to transmit the payment information only once the biometric scan has validated the user.

25. The system of claim 23, wherein the purchasing device is configured to establish a secure link over the air interface only once the biometric scan has validated the user.

26. The system of claim 23, wherein the biometric scan is conducted via a fingerprint scanner.

27. The system of claim 23, wherein the purchasing device is further configured to alert the user to provide a biometric scan once the secure link over the air interface has been established.
